(19) United States
(12) Patent Application Publication
(10) Pub. No.: US 2010/0292947 A1
(43) Pub. Date: Nov. 18, 2010

(54) SCAN HEAD CALIBRATION SYSTEM AND METHOD

(75) Inventor: Mum Fatt Buk, Singapore (SG)

Correspondence Address: OCCHIUTI ROHLICEK & TSAO, LLP, 10 FAWCETT STREET, CAMBRIDGE, MA, 02138, US

(73) Assignee: Hypertronics PTE LTD. a corporation, Singapore (SG)

(21) Appl. No.: 12/739,385

(22) PCT Filed: Oct. 17, 2008
(86) PCT No.: PCT/SG2008/000400

§ 371 Date: Jul. 22, 2010

(30) Foreign Application Priority Data
Oct. 23, 2007 (SG) 200717197-8

(51) Int. Cl. G06F 19/00

(52) U.S. Cl. 702/94

(57) ABSTRACT

A method and system are provided for reducing a positioning error for positioning a light beam either onto or from a workpiece. A calibration mark is provided, and an image of the calibration mark is captured, to compare with a guide mark. The position of the guide mark corresponds to a set of design data or coordinates. The position of the image of the calibration mark is adjusted until the image matches with the guide mark. A set of vision compensating factors can therefore be determined. Thereafter, an image of a laser mark is captured, and adjusted to match the guide mark, to determine a set of scan head compensating factors. The design data can then be modified based on the vision compensating factors and the laser compensating factors, and used to position the laser beam onto the workpiece or capture light from a work piece to form an image.

### TECHNICAL FIELD

The present invention relates to a Scan Head calibration system and method. In particular, it relates to a system and method for vision scanning and laser beam delivery at high positional accuracy.

### BACKGROUND

Precision positioning of light rays such as visible light beams and/or laser beams are required in certain industrial applications, such as vision inspection and laser processing. One example is laser marking for creating visually perceptible signs at pre-defined locations of a workpiece using a laser beam. Apart from marking, laser systems can also be used in other applications such as micro-machining, surface processing, trimming, welding, and cutting, etc.

In a laser marking, welding or machining process, coordinate data or parameters of the predetermined locations on a workpiece at which the process is to be carried out, are programmed into a laser beam positioning controller, with reference to a coordinate system. Under an ideal situation, the laser beam should be directed onto the workpiece at locations corresponding to the coordinate data by which, laser processing can be carried out at the predetermined locations.

In an actual situation, however, the laser beam is not always directed to predetermined locations on the workpiece. This may be due to the system errors and/or installation tolerances of the laser positioning mechanism. Without taking these errors and/or tolerances into consideration, laser beam may be directed at undesired positions on the workpiece, which is unacceptable. In a process which requires even higher positioning accuracy, such as a precision welding process used for welding a read/write head onto a suspension assembly in a disk drive device, miss-positioning of the laser beam may result in a complete failure of the welding process. Similar concerns may arise in a vision inspection system, either stand alone or incorporated in a laser processing system. Accordingly, positioning accuracy of light rays becomes one of the key factors to ensure the accuracy and quality of vision inspection and laser processing.

It is therefore desirable to provide a Scan Head calibration system and method for vision inspection and/or laser processing, with system errors well compensated or at least substantially reduced, so as to carry out these processes in high positional accuracy. Such a system and method are currently unavailable.

### SUMMARY OF THE INVENTION

Embodiments of the present invention provide solutions for reducing positional errors in a laser delivery system, and calibrating a scan vision system which may be either an independent system for vision detection, optical inspection and/or precision measurements, or a scan assembly integrated into a laser delivery system.

According to one embodiment, there is provided a method for reducing a positioning error in a laser processing system for positioning a laser beam onto a workpiece. A calibration mark is provided, and an image of the calibration mark is captured, to compare with a guide mark. The position of the guide mark corresponds to a set of design data or coordinates. The position of the image of the calibration mark is adjusted until the image matches with the guide mark. A set of vision compensating factors can therefore be determined. Thereafter, an image of a laser mark is captured, and adjusted to match the guide mark, to determine a set of laser compensating factors. The set of design data can then be modified based on the vision compensating factors and the laser compensating factors, and used to position the laser beam onto the workpiece.

According to another embodiment, there is provided a method for calibrating a scan vision system. A calibration mark is provided, and an image of the calibration mark is captured, to compare with a guide mark. The position of the guide mark corresponds to a set of design data or coordinates. The position of the image of the calibration mark is adjusted until the image matches with the guide mark. A set of vision compensating factors can therefore be determined, and used to modify the set of design data to calibrate the scan vision system.

Solutions provided by the present invention can significantly reduce system errors and increase positional accuracies in scan vision systems and laser processing systems. Laser processing systems calibrated according to embodiments of the present invention achieves a high accuracy level to cater the needs for precision laser processing, such as laser marking and laser welding.

### BRIEF DESCRIPTION OF THE DRAWINGS

These and other aspects and advantages of the present invention will be described in detail with reference to the accompanying drawings, in which:

FIG. 1A is a schematic diagram showing a laser marking apparatus according to one embodiment of the present invention;

FIG. 1B is a schematic diagram showing a laser marking apparatus of FIG. 1A, and having a calibration jig placed thereon for calibration, or a workpiece placed thereon for processing;

FIG. 2 is a schematic diagram showing a scan vision system according to one embodiment of the present invention;

FIG. 3A is a schematic diagram showing a laser calibration system according to one embodiment of the present invention;

FIG. 3B is a top view of a calibration jig used for calibrating a laser system shown in FIG. 3A;

FIG. 3C is a schematic view of a set of guide marks and an image of the calibration jig of FIG. 3B;

FIG. 4 is a schematic diagram showing a set of guide marks for calibrating a vision system according to one embodiment of the present invention;

FIG. 5A is a schematic diagram showing an image of a set of calibration marks captured for calibration;

FIG. 5B is a schematic diagram showing the image of FIG. 5A after vision proportional factors are properly calibrated;

FIG. 5C is a schematic diagram showing the image of FIG. 5A after vision distortion factors are properly calibrated;

FIG. 6A is a schematic diagram showing the image of FIG. 5A for half scan field calibration;

FIG. 6B is a schematic diagram showing the image of FIG. 5A when zoomed-in to the half scan field calibration;

FIG. 7A is a schematic diagram showing an image of a laser mark in a full scan field for laser assembly calibration;

FIG. 7B is a schematic diagram showing an image of FIG. 7A after the laser assembly is calibrated at the full scan field;

FIG. 8A is a schematic diagram showing an image of a laser mark in a half scan field for laser assembly calibration; and

FIG. 8B is a schematic diagram showing an image of FIG. 8A after the laser assembly is calibrated at the half scan field.

### DETAILED DESCRIPTION OF THE PREFERRED EMBODIMENTS

For the purpose of illustration, embodiments of the present invention will be described to a system and a method suitable for laser processing at high positional accuracy, which may be described with respect to the reduction and/or compensation of system errors for precisely positioning a laser beam onto a workpiece for laser processing.

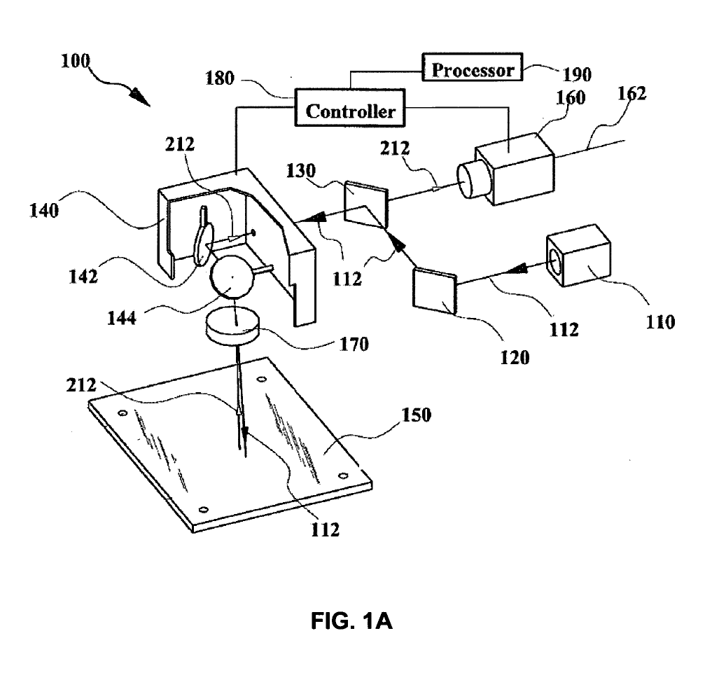

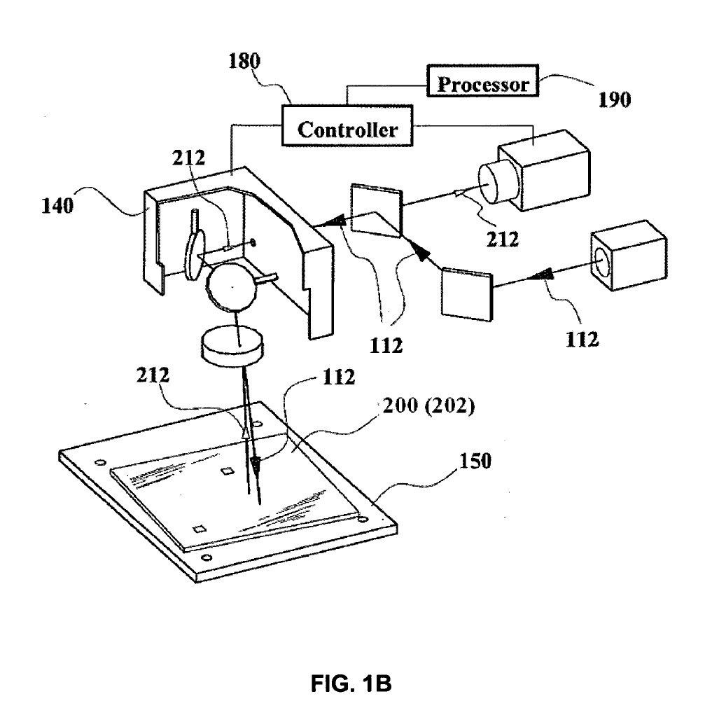

FIG. 1A shows a laser processing system 100 for processing a workpiece, for example to mark the workpiece or weld the workpiece, according to one embodiment of the present invention. FIG. 1B shows the system of FIG. 1A and having a calibration jig placed thereon for vision assembly calibration, or a workpiece placed thereon for processing.

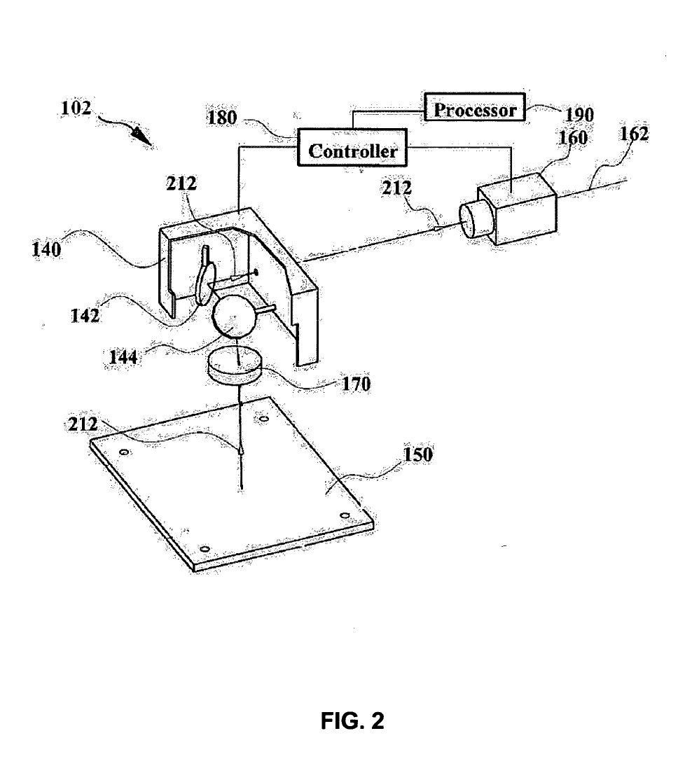

FIG. 2 shows a scan vision system 102, according to one embodiment of the present invention. Scan vision system 102 may be used as an independent system for vision detection, optical inspection and/or precision measurement. Alternatively, vision system 102 may also be used as a scan vision assembly or scan vision module integrated in a laser processing system shown in FIG. 1A. For the purpose of illustration, same reference numerals are used in FIGS. 1A, 1B and 2 for the scan vision assembly of laser processing system 100 and the independent scan vision system 102. However, it should be understood that scan vision systems other than that shown in FIG. 2 may also be used as a scan vision assembly or module in laser processing systems.

As shown in FIGS. 1A and 1B, laser processing system 100 has a laser source 110, such as a YAG laser or a CO2 laser, for providing a laser beam 112 with an energy level sufficient to process a workpiece. A first mirror 120 deflects laser beam 112 to a second mirror 130. Second mirror 130 further deflects laser beam 112 to a guiding optic assembly, such as a scan head 140. Two galvo-controlled mirrors 142 and 144 are provided in scan head 140 for receiving and further directing laser beam 112 onto a platform 150. Platform 150 is provided to support a workpiece 200 thereon for laser processing, or a calibration jig 202 for calibration. Galvo mirrors 142 and 144 are axially aligned in an orthogonal arrangement. Each galvo mirror is independently mounted on a corresponding pivotal axis. Scan head 140 having two galvo mirrors 142 and 144 arranged in the above manner is capable of deflecting, directing and steering laser beam 112 along an X direction and a Y direction, respectively, so that laser beam 112 can reach any position within the two-dimensional environment of platform 150.

Laser processing system 100 has a vision detector 160, such as a CCD camera, for receiving and detecting visible light beam 212 from platform 150, workpiece 200 and/or calibration jig 202. Vision detector 160 is placed behind second mirror 130. Second mirror 130 is a dichroic mirror which reflects the laser beam and allows the visible light to pass through. Vision detector 160, dichroic mirror 130, galvo mirrors 142 and 144 and focusing lens 170 form a scan vision assembly. Laser source 110, deflection mirror 120 dichroic mirror 130, galvo mirrors 142 and 144 and focusing lens 170 form a laser assembly.

Vision detector 160 is positioned with its optical axis 162 in alignment with a path of laser beam 112 between galvo mirror 142 and second mirror 130. By this arrangement, visible light 212 from workpiece 200, platform 150 or calibration jig 202 travels along a same path as the laser beam 112, between second mirror 130 and focusing lens 170. Accordingly, galvo-mirrors 142 and 144 can be set at positions according to coordinate data to direct laser beam 112 onto the platform 150, workpiece 200 or calibration jig 202 at corresponding locations, and to decode a coordinate data of visible light beam 212 received by vision detector 160.

A controller 180 is coupled to scan head 140 and vision detector 160. A processor 190 is coupled to controller 180. Controller 180 outputs coordinate data to scan head 140, and controls the rotation and positioning of galvo mirrors 142, 144 to deflect laser beam 112 onto platform 150 and direct visible light beam 212 back to vision detector 160.

As shown in FIG. 2, scan vision system 102 according to the present embodiment has a similar set up as the scan vision assembly of the laser processing system 100 shown in FIG. 1A. The operation and calibration process of the scan vision assembly of the laser processing system illustrated below is therefore applicable for the calibration of scan vision system 102. Note that being an independent scan vision system, the vision detector 160 receives light beam 212 directly from the platform/workpiece, therefore a dichroic mirror is not necessary in scan vision system 102.

According to the present embodiment, in the laser processing system shown in FIG. 1A, firstly, the scan vision assembly is calibrated, as illustrated below.

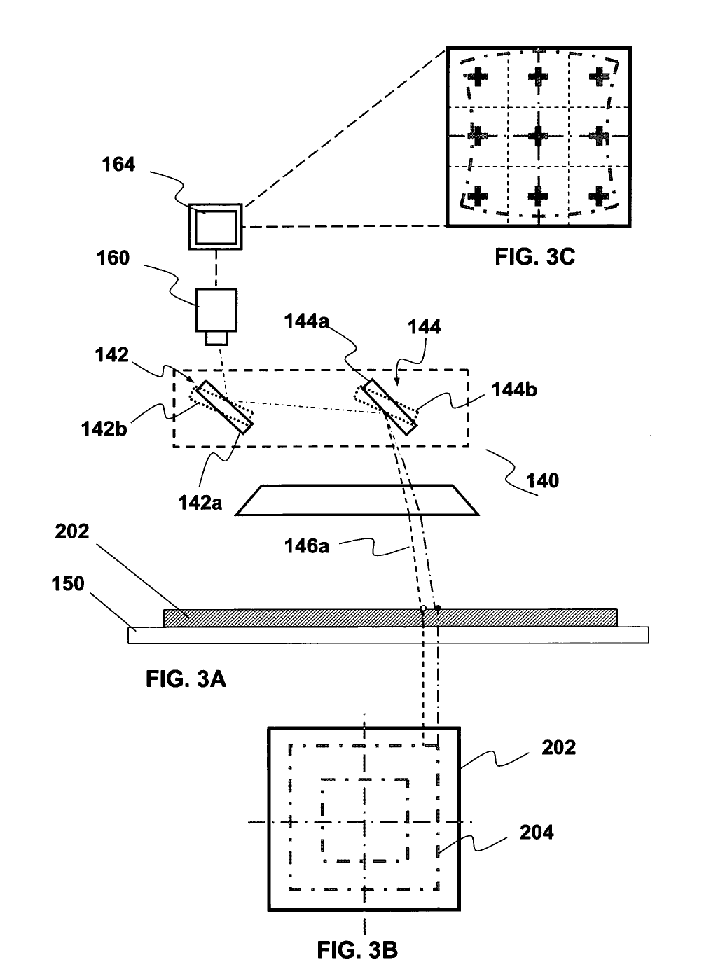

FIG. 3A is a schematic diagram of the laser system of FIG. 1 configured for scan vision assembly calibration according to one embodiment of the present invention. Prior to the whole system calibration process, both the laser assembly and the scan vision assembly are adjusted to focus the respective laser/visible-light beam to/from the workpiece. The system focus adjustment is done by adjusting the laser focus height above the platform, followed by adjusting the scan vision assembly to focus on the same plane on the platform. Once the focusing is set, the vision detector lens is locked to prevent any accidental focus change. Thereafter, the laser assembly and the vision assembly are aligned with respect to the center point of the scan field. A calibration jig 202 is then placed on platform 150 for the calibration of the vision assembly.

The calibration jig 202 has a glass jig made of optical glass with precision lithographic patterns and predefined scales on the top surface, as shown in FIG. 3B. The glass jig is fabricated with calibration marks 204 having a high positional accuracy

As a starting point, the system is set in such a way to direct the laser beam perpendicular to the platform 150 and passing through the geometric center of the focus lens 170, and that the focus lens 170 is set with its main plane parallel to the platform 150.

A set of design coordinate data is then sent to scan head 140, to set the galvo mirrors 142, 144 at initial positions 142a, 144a at which, the vision assembly is fixed along a first vision path 146a. An image of the calibration jig 202 is captured by the vision detector 160, and displayed on a monitor screen 164, shown as an enlarged image in FIG. 3C. Note that in FIG. 3C, the image of the calibration jig is shown exaggeratedly as curve-edged, for the purpose of illustration only. The shape of actual images may vary. Other figures may also not in scale.

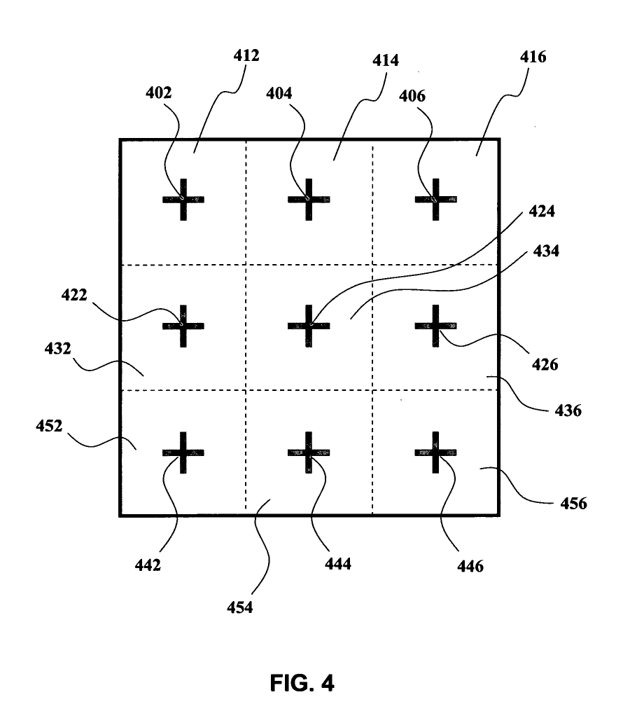

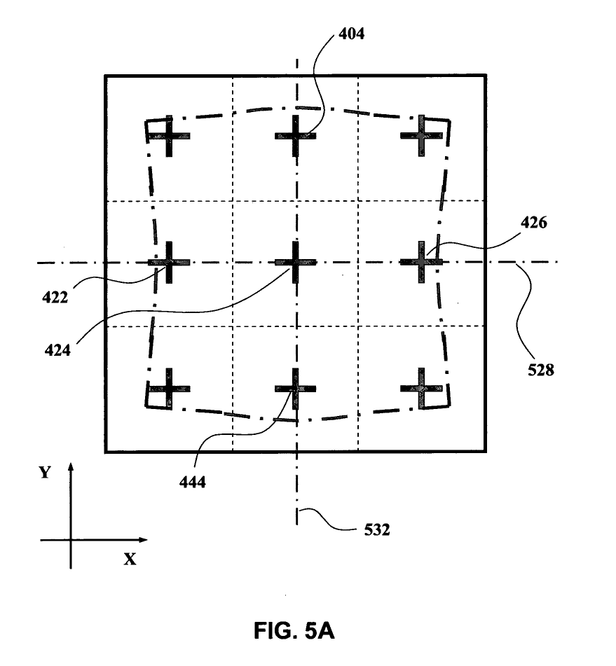

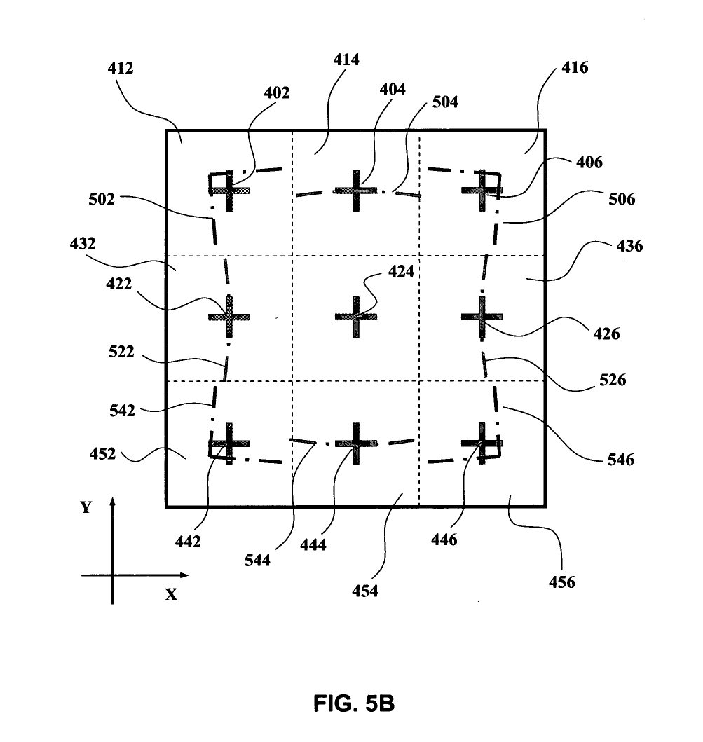

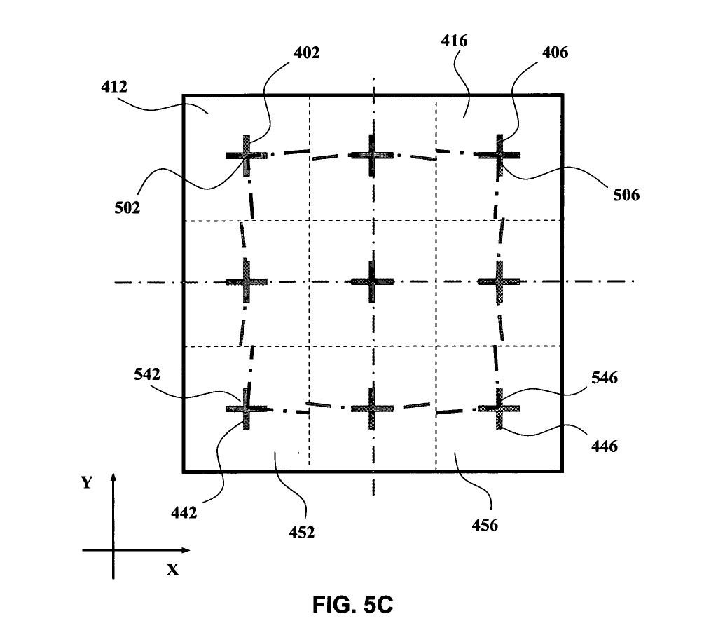

As shown in further detail in FIG. 4, a set of guide marks 402, 404, 406, 422, 424, 426, 442, 444 and 446, shown as crosshairs, are provided in the vision assembly, and displayed on a monitor screen. In the present embodiment, the field of view is divided into 9 segments shown as windows 412, 414, 416, 432, 434, 436, 452, 454 and 456, each having one guide mark located at the center of the corresponding segment. The position of each guide mark corresponds to a set of design coordinate data. Guide marks 402, 406, 442 and 446 define the four corners of a scan vision field. Adjust the calibration jig flatness, skew and position until the center of glass jig image is in alignment with the center of the scan vision field of the vision assembly, i.e. the center guide mark 424. Check the middle-left window 432, middle-center window 434 and middle-right window 436 to observe whether the horizontal center line 528 of the calibration mark perpendicularly intersects with a vertical guide line and overlaps a horizontal guide line for each of the guide marks 422, 424 and 426. If not, adjust the position of the calibration jig along Y-direction to bring the horizontal center line 528 to perpendicularly intersect with vertical guide lines of guide marks 422, 424, and 426. Check the top-center window 414, middle-center window 434 and bottom-center window 454 to observe whether the vertical center line 532 of the calibration mark perpendicularly intersects with a horizontal guide line and substantially overlaps a vertical guide mark of guide marks 404, 424 and 444. If not, adjust the position of the calibration jig along X-direction to bring the vertical center line 532 to perpendicularly intersect with horizontal guide lines and substantially overlap vertical guidelines of guide marks 404, 424 and 444. After the above adjustment, the image of the calibration jig is now shown in FIG. 5A.

Due to system errors, calibration marks on the calibration jig may not be in alignment with corresponding guide marks. To compensate or substantially reduce these errors, an adjustment process is carried out to obtain X and Y direction vision proportional factors, Xprp and Yprp, as well as vision distortion factors (Xd1, Yd1), (Xd2, Yd2), (Xd3, Yd3), and (Xd4, Yd4) of each corner window 412, 416, 452 and 456.

A first step is to calibrate full mark region proportional factors. As shown in FIG. 5B, check the middle-left window 432 to observe whether left edge 522 lithographed on the glass jig is in alignment with corresponding guide mark 422. If not, adjust the galvo mirror position with a set of modified coordinate data, to bring left edge 522 into alignment with corresponding guide mark 422. A proportional factor for middle-left window 432 can therefore be determined based on the set of design coordinate data and the set of modified coordinate data.

Similar adjustment operations are carried out, to bring the right edge 526, top edge 504 and bottom edge 544 into alignment with corresponding guide marks 426, 404 and 444. Respective proportional factors of middle-right window 436, top-center window 414 and bottom-center window 454 can therefore be determined in a similar manner.

After the above adjustments, the proportional factors Xprp and Yprp of the scan vision field can be determined based on the galvo mirror position design coordinate data and modified coordinate data in windows 432, 434, 436, 414 and 454. The adjusted image of the glass jig captured by the vision assembly is now shown in FIG. 5B.

In a next step, distortion factors corresponding to each of the corner image windows 412, 416, 452 and 456 are determined. As shown in FIG. 5B, take the top-left image window 412 as an example, the adjustment is made by varying the galvo mirror positions with a set of modified coordinate data, to bring the calibration mark 502 into alignment with guide mark 402. Similar adjustment operations are made to galvo mirrors corresponding to image windows 416, 452 and 456, to bring the calibration marks 506, 542 and 546 into alignment with corresponding guide marks 406, 442 and 446, respectively.

After the above adjustments, the distortion factors of each corner window can be determined based on the galvo mirror design position coordinate data and modified position coordinate data. The image of the glass jig captured by the vision assembly is now shown in FIG. 5C. According to another embodiment, further calibration is made with respect to the half-sized scan field.

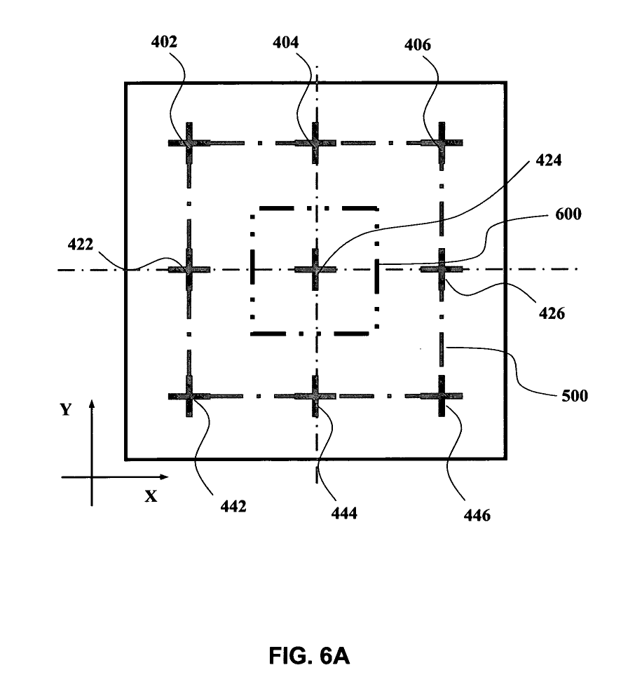

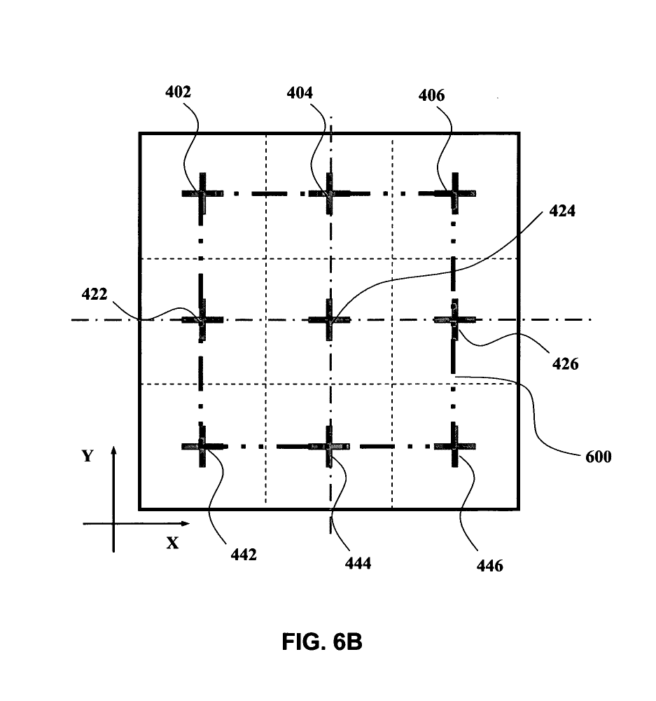

As shown in FIG. 6A, the calibration process according to the previous embodiment is made with respect to the full scan field 500 (shown as single-dotted line). To further reduce the system error, the present embodiment further calibrates the system with respect to the half scan field 600 (shown as double-dotted line).

To start, the image capturing points are changed to the 9 control points of the half-scan field, with the half-scan field 600 shown in the working window on the monitor through the scan vision system. By this set up, the edges of the half-scan field 600 fit the guide marks 402, 404, 406, 422, 424, 426, 442, 444 and 446. Note that same set of guide marks are used in calibrating the half-scan field. It is therefore understood that the set of guide marks are universal to any set of design coordinate data for vision calibration.

Following the similar procedures as described in the previous embodiment for the full scan-field calibration, the half field Proportional factors (Xprp/2 and Yprp/2) can be obtained accordingly, with the aid of the 9-window image, the guide marks and the glass jig scales/calibration. The final alignment is shown in FIG. 6B.

After the above process, X and Y proportion factors of the scan field as well as distortion factors of each corner window area are obtained. These proportion factors and distortion factors will be used to modify the design data for positioning the galvo mirrors in the vision assembly

It should be noted that the calibration process illustrated above may be used to calibrate either an independent scan vision system shown in FIG. 2, or a scan vision assembly/module of a laser processing system shown in FIG. 1A.

In the case of a laser processing system, the above process may be used to calibrate the integrated scan vision assembly/module, to obtain a scan vision accuracy of the same level. The laser assembly can then be calibrated base on the scan vision assembly, as illustrated below.

Remove the scan vision calibration glass jig, and place a sheet of laser sensitive paper (or other suitable materials for laser marking) on the platform. Make sure that the paper is flat and at the same height as the calibration jig.

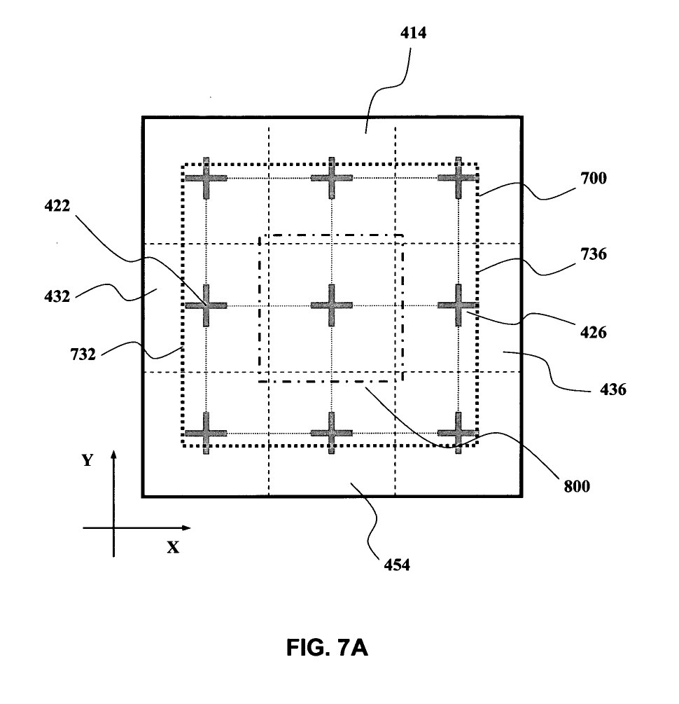

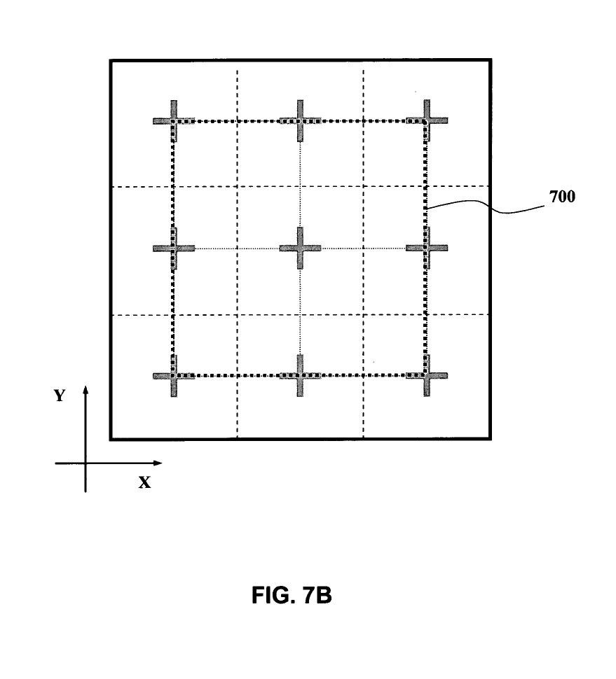

In one embodiment, laser assembly calibration for the full mark field is calibrated. Set the laser output to a proper power level for the laser alignment paper, then mark a full mark field 700 on the laser paper, as shown in FIG. 7A.

Observe the middle-left and middle-right image windows 432 and 436 from the 9-window screen to determine whether the mark field edge 732 and 736 intersect with the galvanometer position at the respective guide marks 422 and 426, at both left and right end.

If not, adjust Laser Proportional factor X until the left and right edges of mark field 700 are in alignment with the corresponding guide marks 422 and 426. Similar steps are carried out for top-center and bottom-center image windows 414 and 454, by adjusting Laser Proportional factor Y, to bring the top and bottom edge of mark field 700 in alignment with the corresponding guide marks 414 and 454. Upon the full field laser calibration, an image of the marked field 700 is shown in FIG. 7B.

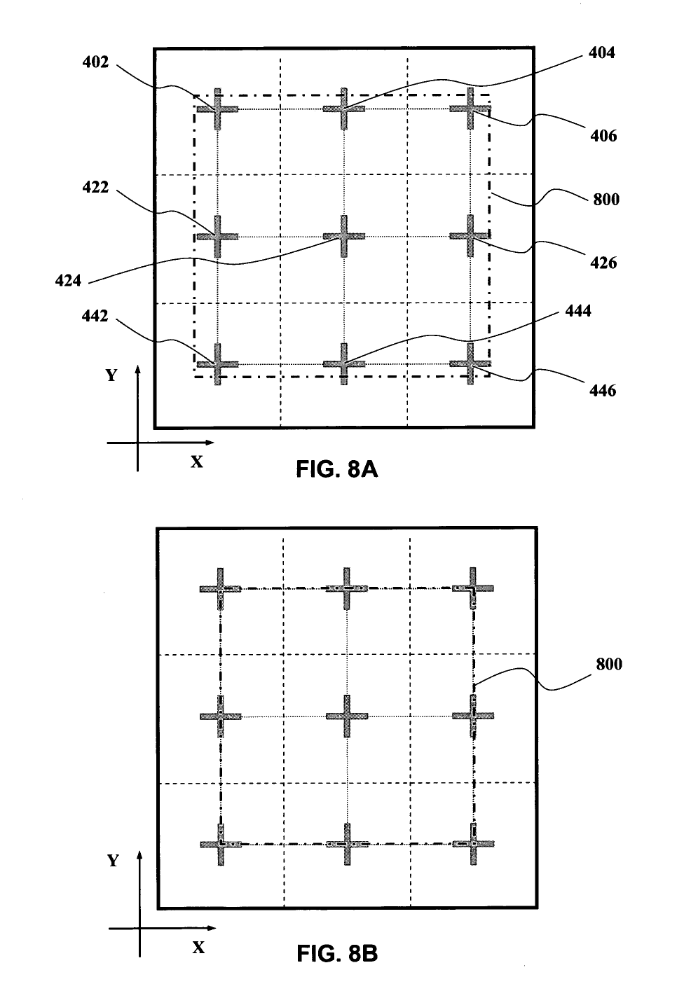

According to another embodiment, further calibration is carried out with respect to the half-sized scan field, as shown in FIG. 8A and in comparison with FIG. 7A.

Create a half field mark 800, and zoom-in the vision detector such that the edges of the half field 800 fit the guide marks 402, 404, 406, 422, 424, 426, 442, 444 and 446. Note that same set of guide marks are used in calibrating the laser compensating factors of the half-scan field. It is therefore understood that the set of guide marks are universal to any set of design coordinate data for laser calibration.

Following the similar procedures as described in the previous embodiment for the full field laser assembly calibration, the half field Laser Proportional factors (X/2 and Y/2) can be determined accordingly, with the aid of the 9-window image and guide marks.

Since the scan-vision is calibrated to the +/−1 μm glass jigs, the scan-vision assembly can achieve an accuracy level of +/−2 μm, with the CCD camera system at a resolution of about 1 μm/pixel. The laser assembly is then calibrated to the scan-vision assembly, to achieve an accuracy level of +/−5 μm. Actual laser testing results on a 1 mm thick stainless steel plate confirmed the calibration accuracy.

As illustrated above, the images shown in FIG. 4 to FIG. 8B are the images the calibration marks captured by the scan-vision system and mapped with the guide marks provided by the scan-vision system, under either the full scan field mode or the half scan field mode. These images are dynamically updated by the vision detector during the process of matching the calibrations marks with the corresponding guide marks. Compensation factors for precise scan-vision capturing and laser positioning are therefore obtained upon completion of the calibration process.

According to a further embodiment, a pixel-to-mm calibration is carried out.

First, the system is taught using a unique pattern at the centre of the scan field, the pattern is preferably as small as possible, but is still recognizable when observed using the vision assembly. The system will then move the galvo mirrors with small a distance calculated in mm, step through from centre to left, centre to right, centre to top, and centre to bottom of the scan field.

In between each step, the vision system will grab one image pattern and obtain the pattern drifting distance from image centre, calculated in pixel. The stepping of galvanometer will stop once the vision system cannot find the learnt pattern and continue with next direction until all direction had been completed. Thus the mm/pixel unit can be calculated for each axis.

Although embodiments of the present invention have been illustrated in conjunction with the accompanying drawings and described in the foregoing detailed description, it should be appreciated that the invention is not limited to the embodiments disclosed. For example, although embodiments are described with respect to a two dimensional scan field environment, and with nine guide marks for the calibration of vision assembly and laser assembly, it is understood by a person skilled in the art that vision and laser assembly calibration may be carried out by using other numbers of guide marks and calibrations marks, and in either a one-dimensional environment or a two-dimensional environment. Whilst a scan vision system or a laser processing system configured with a focusing lens placed between the galvo assembly and the platform is disclosed, as shown in FIGS. 1A and 2, it should be appreciated that embodiments of the present invention may well be used in scan vision system and laser processing system with other configurations. For example, embodiment of present invention may be used for scan vision system or laser processing system having a focusing lens placed between the galvo assembly and the vision detector. It is therefore understood that the present invention is capable of numerous rearrangements, enhancements, modifications, alternatives and substitutions without departing from the spirit of the invention as set forth and recited by the following claims.

1. A method of reducing a positioning error in a laser processing system for positioning a laser beam onto a workpiece, comprising:
providing a calibration mark;
providing a guide mark corresponding to a set of design data;
matching an image of the calibration mark to the guide mark to determine a set of vision compensating, factors;
matching an image of a laser, mark to the guide mark to determine a set of laser compensating factors; and
modifying the set of design data to position the laser beam onto the workpiece using the set of vision compensating factors and the set of laser compensating factors.

2. The method of claim 1, wherein matching the image of the calibration mark to the guide mark further comprises:
fixing a vision assembly along a first vision path based on the set of design data;
obtaining the image of the calibration mark through the vision assembly along the first vision path;
varying the first vision path to a second vision path to bring the image of the calibration mark into alignment with the guide mark, wherein the second vision path corresponds to a set of modified design data; and
determining the set of vision compensating factors from the set of design data and the modified data.

3. The method of claim 1, wherein the calibration mark is a first calibration mark corresponding to a border of a rectangle processing field, wherein the method further comprises providing a plurality of calibration marks corresponding to an opposite border, adjacent borders and corner areas of the rectangle processing field.

4. The method of claim 3, wherein the guide mark is a first guide mark corresponding to the first calibration mark, wherein the method further comprises providing a plurality of guide marks each corresponding to one of the plurality of calibration marks.

5. The method of claim 4, wherein matching each of the plurality of calibration marks to a corresponding one of the plurality of guide marks at opposite borders determines a first vision proportional factor along a first direction, and a second vision proportional factor along a second direction substantially orthogonal to the first direction.

6. The method of claim 4, further comprising determining a distortion factor of a corner area from matching each of the plurality of calibration marks at the corner area to a corresponding one of the plurality of guide marks at the corner area.

7. The method of claim 4, wherein the plurality of guide marks are distributed through a two-dimensional scan-vision field.

8. The method of claim 7, wherein the plurality of guide marks define a full scan-vision field.

9. The method of claim 7, wherein the plurality of guide marks define a half scan-vision field.

10. The method of claim 1, wherein matching the image of the laser mark to the guide mark further comprises:
fixing a laser assembly along a first laser path based on the set of design data;
creating the laser mark;
obtaining the image of the laser mark along the first laser path;
varying the first laser path to a second laser path to bring the image of the laser mark into alignment with the guide mark wherein the second laser path corresponds to a second set of data; and
determining the set of laser compensating factors from the first and second sets of data.

11. The method of claim 10, wherein the laser mark is a first laser mark corresponding to a border of a rectangle processing field, wherein the method further comprises providing a plurality of laser marks corresponding to an opposite border and adjacent borders of the processing field.

12. The method of claim 11, wherein the guide mark is a first guide mark corresponding to the first laser mark, wherein the method further comprises providing a plurality of guide marks each corresponding to one of the plurality of laser marks.

13. The method of claim 12, wherein matching each of the plurality of laser marks to a corresponding one of the plurality of guide marks at opposite borders determines a first laser proportional factor along a first direction and a second laser proportional factor along a second direction substantially orthogonal to the first direction.

14. A method for directing a laser beam onto a workpiece at a predetermined location, the method comprising:
providing a set of design data defining the predetermined location;
providing a guide mark corresponding to the set of design data;
providing a calibration mark;
matching an image of the calibration mark to the guide mark to determine a set of vision compensating factors;
introducing the set of vision compensating factors to the set of design data to generate a set of modified data; and
directing the laser beam onto the workpiece based on the modified data.

15. The method of claim 14, wherein the set of compensating factors includes a set of vision compensating factors and a set of laser compensating factors.

16. The method of claim 15, wherein the set of vision compensating factors is obtained by matching an image of a calibration mark to a guide mark.

17. The method of claim 16, wherein the set of laser compensating factors is obtained by matching an image of a laser calibration mark to the guide mark.

18. An apparatus for reducing a positional error of a laser processing system having a laser assembly and a vision assembly, the apparatus comprising:
a calibration jig having a calibration mark; and
a guide mark provided in the vision assembly wherein the vision assembly is fixable along a first vision path based on a set of design coordinate data to capture an image of the calibration mark, wherein the first vision path is variable to a second vision path based on a set of modified coordinate data to match the image of the calibration mark to the guide mark, and wherein the set of design data and the set of modified data are to determine a vision compensating factor for reducing the positional error.

19. The apparatus of claim 18, wherein the calibration mark is a first calibration mark corresponding to a border of a rectangle processing field, wherein the calibration jig further comprises a plurality of additional calibration marks corresponding to an opposite border, adjacent borders and corner areas of the processing field.

20. The apparatus of claim 19, wherein the guide mark is a first guide mark corresponding to the first calibration mark, wherein the apparatus further comprises a plurality of additional guide marks each corresponding to one of the plurality of additional calibration marks.

21. A method for calibrating a scan vision system, comprising:
providing a calibration mark;
providing a guide mark corresponding to a set of design data;
matching an image of the calibration mark to the guide mark to determine a set of vision compensating factors;
modifying the set of design data using the set of vision compensating factors to generate a set of modified design data; and
calibrating the scan vision system based on the modified design data.

22. The method of claim 21, wherein matching the image of the calibration mark to the guide mark further comprises:
fixing the scan vision system along a first vision path based on the set of design data;
obtaining the image of the calibration mark along the first vision path;
varying the first vision path to a second vision path to align the image of the calibration mark with the guide mark wherein the second vision path corresponds to a set of modified data; and
wherein determining the set of vision compensating factors from the set of design data and the modified data.

23. The method of claim 21, wherein the calibration mark is a first calibration mark corresponding to a border of a rectangle processing field; wherein the method further comprises providing a plurality of calibration marks corresponding to an opposite border, adjacent borders and corner areas of the processing field.

24. The method of claim 23, wherein the guide mark is a first guide mark corresponding to the first calibration mark, wherein the method further comprises providing a plurality of guide marks each corresponding to one of the plurality of calibration marks.

25. The method of claim 24, wherein matching each of the plurality of calibration marks to a corresponding one of the plurality of guide marks at opposite borders determines a first vision proportional factor along a first direction, and a second vision proportional factor along a second direction substantially orthogonal to the first direction.

26. The method of claim 24, wherein matching one of the plurality of calibration marks to a corresponding one of the plurality of guide marks at a corner area determines a distortion factor of said corner area.

27. The method of claim 24, wherein the plurality of guide marks are distributed through a two-dimensional scan-vision field.

28. The method of claim 27, wherein the plurality of guide marks define a full scan-vision field.

29. The method of claim 27, wherein the plurality of guide marks define a half scan-vision field.
